(19) United States
(12) Patent Application Publication
(10) Pub. No.: US 2015/0161846 A1
(43) Pub. Date: Jun. 11, 2015

(54) METHOD AND DEVICE FOR RECOGNIZING A GRAPHIC ELEMENT PRINTED ON A PLAY SLIP

(71) Applicant: MORPHO, Issy Les Moulineaux (FR)

(72) Inventors: Alain ROUH, Issy Les Moulineaux (FR); Jean BEAUDET, Issy Les Moulineaux (FR); Laurent ROSTAING, Issy Les Moulineaux (FR)

(73) Assignee: MORPHO, Issy Les Moulineaux (FR)

(21) Appl. No.: 14/560,546

(22) Filed: Dec. 4, 2014

(30) Foreign Application Priority Data
Dec. 6, 2013 (FR) 13 62265

(51) Int. Cl. G07F 17/32

(52) U.S. Cl. CPC G07F 17/3244; G07F 17/329

(57) ABSTRACT

A method for recognizing a graphic element of technical function which is printed on a play slip (10) is based on a comparison of images. The content of an area (30) of the slip in which the graphic element is printed, is compared to reference images. The method is compatible with any mode for printing the graphic element on the slip: alphanumeric codes, barcodes, logos, pictures which vary according to the game, etc., but only uses one recognition algorithm. The graphic element which is recognized may be any graphic element of technical function, including a graphic element of useful data, in particular a game code (3) or a game symbol, or a reference graphic element for determining a position of the slip.

The present invention relates to a method for recognizing a graphic element of technical function which is printed on a play slip. It also relates to a device for implementing such a method.

### BACKGROUND OF THE INVENTION

Many lottery games, or betting activities based on horse races, sporting events, or any event upon which bets can be placed, use play slips which are issued to the player. After the player has made his selection, for example by selecting one of multiple proposals, and has recorded his or her selection on the play slip, this slip is processed by a reading device. The device reads the gaming selection that was made by the player, but also at least one other element, including a code that identifies the game in which the player is participating. This code determines the rules of the game in which the player is participating. It is possible for one same type of play slip to be shared by several different games, for example games having different rules while having the same graphical presentation on the slip. In this case, the slips relating to different games are distinguished by the game codes printed on these slips: two different games are identified by different codes.

The game code is printed on the slip in addition to the selection that was made by the player for his or her bet or play, and is read automatically by the device. However, multiple modes are used for encoding and printing the game codes on the slips: alphanumeric writing, bar codes, locations of position indicators, coding formats specific to the company producing the game or specific to a game category, etc. Several reading algorithms must then be implemented in the play slip reading device, to identify the game codes printed on them. In particular, a character recognition algorithm is used to read alphanumeric game codes, a bar code reading algorithm for cases with prints of that type, etc. Different reading algorithms are thus required, each specific to a print type, which complicates the operation of the play slip reading device. Some other disadvantages of this situation are:

it is necessary to determine the print mode that is used for the game code, on the play slip to be processed, prior to reading it;

each algorithm must be developed and tested separately, particularly concerning its reading error rate;

any updates concern each algorithm independently of the others, multiplying the update operations that may be necessary;

the printing modes used for the game codes must be known beforehand so that the device can be used. In other words, a new game code writing mode cannot be introduced without adding the corresponding reading algorithm to all the reading devices already in service; and

all the printing modes used must be designed to minimize the reading error rate.

It is also known to use position indicators, such as boxes with fixed shapes, for determining the position of the play slip in the reading device. Dark rectangles, usually uniform in color, are commonly used for such position indicators. Such a determination of the slip position is used in particular for reading the game code at the location on the slip where this code is printed. Other indicators may also be printed on the play slips to facilitate decoding, such as evenly spaced indicators called “clock marks.” However, all these indicators, which are technical in function, are searched for in an image of each play slip by performing pattern recognition analysis.

Starting from this situation, an object aim of the invention is to determine a graphic element of technical function which is printed on each slip issued to a player, in a novel manner that avoids or reduces the disadvantages mentioned above.

An additional aim of the invention is to reduce the size of the graphic element searched for on the play slip, while maintaining reliability and robustness in its recognition.

Yet another object of the invention can be to allow combining a graphic element that is solely technical in nature, with at least one other graphic element appearing on the play slips, particularly with a decorative graphic element. Thus, graphic elements that are technical in function but which are unattractive in themselves can be integrated into other graphic elements that are more aesthetic.

### SUMMARY OF THE INVENTION

To achieve this, a first aspect of the invention provides a method for recognizing a graphic element that is printed on a play slip issued to a player, said method comprising the steps of:
/1/ providing a series of reference images that each contain a representation of a graphic element, in form of records of these reference images;
/2/ capturing at least one image of the slip issued to the player;
/3/ within the image of the slip, selecting an image portion that contains a reproduction of the graphic element as this graphic element appears on the slip;
/4/ comparing the reproduction of the graphic element contained in the selected image portion with each reference image, and for each of the reference images, obtaining a score that quantifies a similarity between the reproduction of the graphic element and the reference image;
/5/ proposing the graphic element of the reference image for which the score is the highest, as a graphic element that is recognized for the slip; and
/6/ optionally carrying out a processing based on the graphic element of technical function as proposed in step /5/ as the recognized graphic element. Such processing, possibly automated, may be the execution of part of a game, or a use of the play slip.

Thus, a method according to the invention does not proceed by reading or recognizing characters or patterns, but by comparing image contents, between the image portion selected within the slip as containing the printed graphic element, and the reference images which serve as representation models for each graphic element. Thus, the graphic element recognition proposed by the invention does not implement any interpretation of reads, but only a comparison of the levels of similarity between the graphic element as it appears on the slip and each graphic element as it appears in the reference images. The result of the recognition is provided by the reference image having the greatest similarity.

In other words, the invention operates directly at image level, performing image comparison, unlike reading methods which involve a combination of operations of selection, extraction, and interpretation of characters or code segments that are printed on the slips.

The invention therefore only requires a single image comparison algorithm, able to generate a similarity score for each pair of images compared to one another. This comparison algorithm is applicable regardless of the printing mode that is used for the graphic element, without restricting the introduction of new encoding and printing modes, and with no need to adapt the devices installed before such new encoding and printing methods are developed and used.

In particular, the method of the invention is compatible with a wide variety of printing and encoding modes, including alphanumeric codes, barcodes, logos or drawings, possibly differentiated by colors or grayscales, illustrations or photographs, etc. In particular, the printing mode for the graphic element of technical function on the slip can be integrated with a decorative element of the slip, or a part of the background, for example a decorative background that extends over the slip beyond an area of significance for the graphic element.

Finally, the recognition error rate of a method according to the invention can be particularly low, due to the absence of a reading interpretation step.

The graphic element of technical function to which the method of the invention can be applied may be varied. In particular, the technical function may relate to a selection of the game, a principle of the game, an implementation of the game, useful printed data, a use of the play slip, an automated or non-automated processing of the play slip, or a combination of multiple technical functions. For example, the graphic element may comprise a game code or a game symbol, or a reference graphic element for determining a position of the slip. In general in the invention, the graphic element of technical function provides useful features, as opposed to decorative or advertising-related graphic elements that may also be printed on each play slip.

In some first possible improvements of the invention, the image portion of the slip, which contains the printed graphic element, may be determined progressively. To this purpose, step /3/ may comprise the following substeps:

/3-1/ in the captured image of the slip, detecting position indicators printed on the slip; then

/3-2/ from the indicators, determining a position of the image portion which contains the reproduction of the graphic element as this graphic element appears on the slip.

The image portion is then selected in the image of the slip at the position that was determined in substep /b 3-2/. It is possible for substep /3-1/ to include an identification in the image captured in step /2/ of an area of the image which is occupied by the slip. In this case, the indicators are detected within that area.

It is possible for the location of the reproduction of the graphic element in each slip to vary depending on the game. In this case, an identification of the location may additionally be provided in step /1/ for each reference image. Step /3/ is then repeated for each reference image, using the location identification that corresponds to the reference image for which step /4/ is then executed.

Second possible improvements allow more reliably comparing the representations of the graphic element on the slip and in each reference image. To achieve this, at least one imaging correction may be applied to the image portion which contains the reproduction of the graphic element as the element appears on the slip. This imaging correction is determined in order to increase the similarity between the reproduction of the graphic element that appears on the slip, and the reference image for the current comparison. The similarity score then quantifies the similarity between the reproduction of the graphic element as resulting from the imaging correction applied to the image portion, and the reference image. Such imaging correction may involve at least one of the following parameters: level of brightness, contrast, sharpness, size, orientation or angle of view, for the reproduction of the graphic element as it appears in the image portion.

In third optional improvements of the invention, the method may further comprise, after step /5/, a test to estimate the reliability of the graphic element recognition. If the test is positive, the proposed graphic element is confirmed as the graphic element that is recognized on the slip. If the test is negative, then an estimate of the reliability is generated. The test which is used to estimate the reliability of the graphic element recognition may be:

a comparison with a reliability threshold, of the difference between the highest score and the next highest score in descending order of the scores obtained for all the reference images, the test being positive when the difference is greater than or equal to the reliability threshold;

a comparison of the highest score with a reliability threshold, the test being positive when the highest score is greater than or equal to the reliability threshold; or

an imaging quality sufficiency criterion, for the image portion which contains the reproduction of the graphic element as this graphic element appears on the slip.

It is possible for a combination of these tests to be used.

It is possible, when the test is negative, to further require a validation of the proposed graphic element. Such validation may be decided by the player or by a supplier of the slip to the player, or may be decided using additional content of the slip further to the reproduction of the graphic element. For example, the validation may be determined automatically based on consistency between the additional content of the slip and data associated with the proposed graphic element. When the graphic element comprises a game code or a game symbol, the additional content that is used for this may include a selection from among multiple proposals which is written down by the player on the slip, and the data associated with the proposed game code or game symbol may include rules of that game. in other words, there is a search for consistency between the selection made by the player for playing and the rules for the game among the available games that is deduced from the image comparison.

In general, a method according to the invention can be implemented at a point of distribution of the play slip.

A second aspect of the invention provides a device for recognizing a graphic element of technical function that is printed on a play slip. This device of the invention comprises:
means for storing a series of reference images that each contain a representation of a graphic element of technical function, in form of records of these reference images;
image capture means, adapted to capture at least one image of the play slip;
image analysis means, adapted to select, within an image of the play slip, an image portion that contains a reproduction of the graphic element of technical function as this graphic element appears on the slip;
comparison means, adapted to compare the reproduction of the graphic element to each stored reference image so as to produce, for each of the reference images, a score that quantifies a similarity between the reproduction of the graphic element and the reference image;
means for selecting the graphic element of the reference image for which the score is the highest, and for proposing that selected graphic element as a recognized graphic element for the slip; and
optionally, means for carrying out a processing based on the proposed graphic element of technical function as a recognized graphic element.

Such a device is suitable for implementing a method that is consistent with the first aspect of the invention, including the optional improvements. In particular, when the graphic element to be recognized is a game code or a game symbol, and when a selection among several proposals is written on the play slip, the device may be further adapted to read this selection and to validate the proposed game code or game symbol based on the consistency between the selection read and the rules of the game having this code or symbol.

### BRIEF DESCRIPTION OF THE DRAWINGS

Other features and advantages of the invention will become apparent from the following description of some non-limiting exemplary embodiments, with reference to the accompanying drawings, in which:

FIG. 1 schematically represents a play slip with which the invention can be implemented; and

FIG. 2 is a diagram of the steps of a method according to the invention.

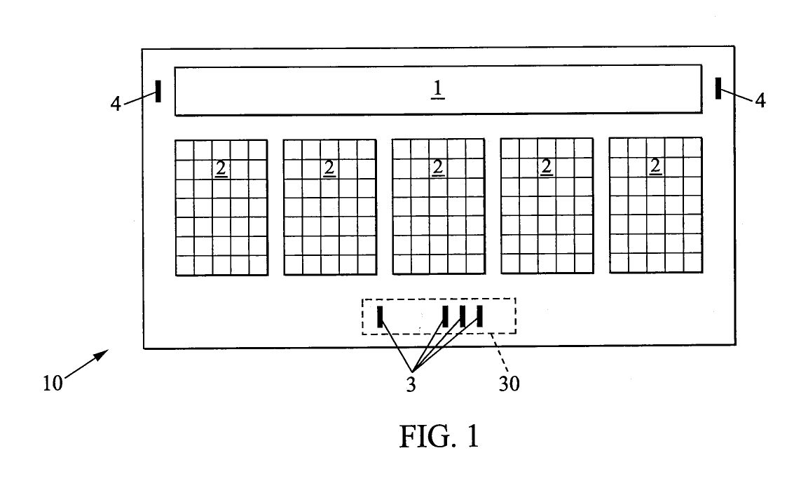

For clarity, the dimensions of the elements represented in FIG. 1 do not correspond to actual dimensions nor to actual dimension ratios.

### DETAILED DESCRIPTION OF THE INVENTION

The invention is now described in detail for the case where a game code is the graphic element of technical function which is recognized when applying the invention, but it is understood that this is only one particular application of the invention, given by way of illustration.

As shown in FIG. 1, a play slip or game ticket, which is denoted by the general reference 10, comprises a plurality of areas including:
a title area or decorative area 1,
one or more grids 2, where the player indicates his play selections, and
a game code 3 in an area 30 which is dedicated to containing the print of the code 3, and
position indicators 4, which the different areas of the slip 10 are arranged in relation to and which can be located.

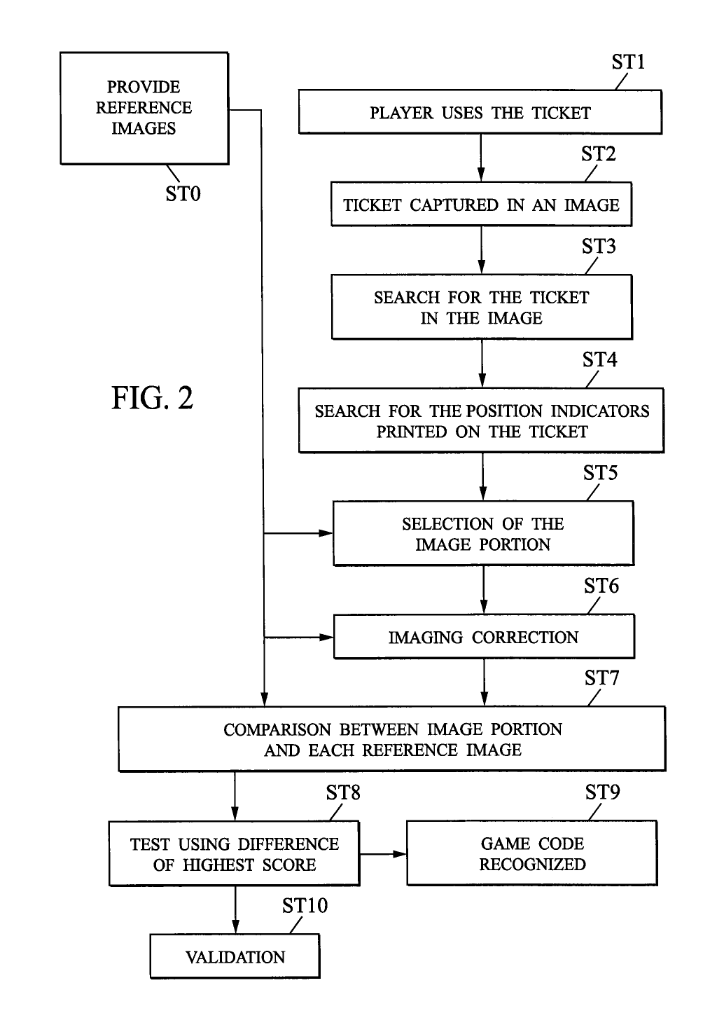

In the invention, the game code 3 can be printed in any form or format within area 30. Area 30 may itself have any peripheral shape: rectangular or some other shape. The game code that is printed is captured in an image then is compared to reference records. The preliminary step ST0 of FIG. 2 consists of providing these reference records for a set of games available to the player. For example, a separate record is provided for each game, which consists of an image of the game code as this code is supposed to be printed on each game participation slip. However, it is possible that the same game can be alternately identified by a number of codes, in which case a separate reference image is provided for each of the codes. It is also possible that several reference images correspond to the same game code, in particular to reduce the risk that a single reference image provided for one same game code has poor image quality. To this purpose, the reference images provided for a game code are preferably captured under conditions independent from one reference image to another. For example, twenty or so reference images may be available in total for all games offered, and each play slip will be analyzed against them.

It is possible for each reference image to be a representation of a complete slip for the corresponding game, which is used as the model for the rest of the process. In this case, the reference image may then be reduced to a portion thereof, corresponding to area 30.

It is possible that the location of the reproduction of the game code within each play slip will not be the same for different games. In this case, an identification of the location is also provided in step ST0 for each reference image, and is associated with the record for this reference image. The location of the reproduction of the game code can be identified in various ways. For example, geometric coordinates that are based on the position indicators 4, or on the edges of the play slip 10, can identify the location of the reproduction of the game code on the slip. Alternatively, the location of the reproduction of the game code on the slip may be identified by a mask which is intended to be superimposed by computer onto an image of the slip. Such a mask then has a selection window that directly corresponds to the area 30. In particular, vector or bitmap formats may be used to identify the location of the reproduction of the game code in each play slip.

When each reference image is a representation of an entire slip of the corresponding game, the portion thereof which corresponds to area 30 may be determined by applying the identification of the location of the reproduction of the game code to the reference image itself.

A play slip recognition device, according to the invention, is intended to be installed at a point of sale or point of distribution of the slips. Reference images can then be sent to the device, via a communication network to which the device is connected, when reference images are updated or to add a new reference image, for example when a new game is started. All reference images can be stored in the device on a suitable data storage medium.

To participate in one of the games at the point of distribution, a player acquires a slip that corresponds to this game, and then uses it according to the rules of the game (step ST1 of FIG. 2). Such use may include selecting some numbers that are indicated in the grids 2, or scratching to reveal a combination that is initially hidden, etc. The method of the invention relates to identifying the game code for the game in which the player is participating, according to the play slip used.

In step ST2, an image of the slip 10 is captured using a photographic device which may be incorporated into the device, in a known manner. In order to be able to use the same device for play slips of different sizes and shapes, the field of the image that is captured is advantageously larger than the play slip 10. Each image can thus represent an entire slip. Preferably, multiple images can be captured for the same play slip, for example in the form of a short video, and the image having the highest contrast or sharpness is selected.

The purpose of steps ST3 to ST5 is to extract the code area 30 from the captured image. Progressive convergence towards this area 30 may be used, to ensure that the area 30 is ultimately found within all analyzed slips. First, step ST3 may consist of searching for the edges of the slip 10 in the image that has been captured. Such a search for the edges of the slip may be based on variations in color or contrast between the slip itself and the background in the captured image. Additionally or alternatively, detection of straight lines in the captured image may be applied in order to find the edges of the slip 10 in the image. Such methods are known to those skilled in the art of image analysis, so it is unnecessary to describe them here. The image area that is occupied by the slip is then known by its peripheral boundaries, which correspond to the edges of the slip. Then step ST4 can consist of searching for the position indicators 4 within the image area that is occupied by the slip 10. The indicators 4 can be identified by their shape, color, or contrast. Optionally an initial estimate of the locations of the indicators 4 in the image may be obtained from the shape of the slip, as this shape was identified in step ST3. Finally, in step ST5, the area 30 is precisely identified in the captured image, within the area of the image that is occupied by the entire slip 10. This identification of area 30 can be performed from the positions of the indicators 4 in the captured image, or directly from the edges of the slip 10 as detected in the captured image.

Steps ST6 and ST7 consist in comparing the portion of the captured image which corresponds to area 30, with each of the reference images provided in step ST0. Steps ST6 and ST7 are therefore repeated for each of the reference images, for the same play slip 10.

When the location of the reproduction of the code in the slip 10 can vary for games that are different, the sequence of steps ST5 to ST7 is repeated for each reference image to which the slip 10 is compared. Thus, independently for each of the reference images, the image portion in the image that was captured in step ST2 is again selected in step ST5, assuming that this reference image corresponds to the same game as the slip 10. The identification of the location of the game code in the slip, stored for the reference image currently being used, is applied. It is the negative result ultimately obtained for the comparison between the content of the image portion thus selected and the reference image, which will eliminate attempts where the image portion that has been selected does not contain the reproduction of the game code.

According to one of the features of the invention, the comparison in step ST7 is carried out at the level of the image contents, with no reading or interpretation operation.

In practice, one of the game codes is reproduced on each slip using standard reprographic methods. However, such methods may introduce geometric distortions, or altered colors, or reduced sharpness, etc., which are variable and not controlled. For this reason, the game code may be imperfectly reproduced on the slip 10, in comparison to the same game code as contained in the corresponding reference image. In addition, the play slip may have been somewhat damaged, for example creased or faded by unintentional friction. In addition, the image capture in step ST2 may also introduce additional geometric distortions, color alterations, reduced sharpness, etc., relative to those caused by the reprographic process used to print the slip 10.

It is then necessary for the result of the image comparison to be robust in handling such defects due to reprography, slip deterioration, and imaging. To make this comparison more robust when there may be such potential defects or such variations in the conditions of the image capture performed in step ST2, one or more imaging corrections may be applied to the image portion corresponding to area 30 of the slip 10. Among the imaging corrections that are known, the following are photometric corrections: adjusting the color saturation scale, filtering local variations in brightness, and sharpness correction. The color saturation scale adjustment provides, in the image portion corresponding to area 30, an average level of illumination and/or a contrast which are equivalent to those of the reference image. Filtering the local variations in brightness eliminates image noise that could be caused by inadvertent creasing of the slip 10, or by the slip being curved while holding it when the image is captured. Geometric type imaging corrections may relate to the apparent size of area 30 in the image portion, its orientation, or angle of view, compared to the reference image. Such corrections are performed by homothetic or projective transformations which are determined by comparing noteworthy points or lines in the portion of the captured image and in the reference image. In a known manner, a geometric readjustment to the sub-pixel level may thus be achieved, meaning that the image portion can be realigned with respect to the reference image with a finer precision than the pitch of the pixels in each image. The imaging corrections are applied to the portion of the captured image that reproduces area 30 of the slip 10, but in the form of a record that is separate from that of the image capture to allow recovering at a later time the image as it was captured, in particular for comparing it with another reference image. Finally, the image portion which is thus corrected is compared with the reference image. Image comparison algorithms are known to those skilled in the art. The results include a numerical value that measures the level of similarity between the images being compared. This value was called a score in the general part of this description. Thus, for the slip 10 that is being processed, a similarity score is obtained relative to each of the stored reference images.

In alternative implementations of the method, the imaging corrections or some of the imaging corrections may be applied to the reference image for the current comparison, instead of being applied to the image portion which reproduces area 30 of the slip 10. Each imaging correction is then determined to increase the similarity between the reproduction of the game code 3 as it appears on the slip 10, and the reference image after the latter has been corrected. Obviously, imaging corrections that would thus be applied to the reference image use a record of the image that is separate from the one provided in step ST0 in order to be able to access the initial reference image at a later time. The imaging corrections already mentioned above, for the image portion of the slip 10 which corresponds to area 30, can therefore thus be applied to the reference images. Some imaging corrections may also be applied to both the image portion of the slip 10 and to the reference image.

Finally, steps ST8 to ST10 concern the decision process leading to presenting one of the game codes of the reference images as the one recognized on the slip 10.

For example, the two highest scores may be selected from among all the scores that were obtained for the reference images provided in step ST0, and the difference between these two highest scores is calculated in step ST8. This difference can be considered as a measurement of any doubt that could exist between the two reference images most similar to the reproduction of the game code appearing on the slip 10. If the difference is greater than or equal to an initially fixed reliability threshold, then the reference image for which the highest score was obtained is considered to be the one corresponding to the reproduction of the slip 10, and the corresponding game code is presented as having been recognized on the slip 10 (step ST9).

Conversely, when the difference between the two highest scores is less than the reliability threshold, an estimated value of the reliability of the proposed game code may be issued by the device. This value may be the difference between the two highest scores in the test case just described. If the reliability is deemed to be insufficient, then the method may be repeated from step ST2. Alternatively, validation that the game code of the reference image whose score is the highest, is identical to the code written on the slip 10, may be requested (step ST10). Such validation may be performed by the player or by the agent who issued the slip 10. Alternatively, other validation methods may be used which require no player or agent intervention. For example, the validation can be confirmed or denied by looking for consistency between the game code of the reference image for which the highest score was obtained, and other content features or elements of the slip 10. Among such content elements of the slip 10, the bet or play selection made by the player can itself be used. This selection is read automatically. Its consistency with the rules of the game corresponding to the highest score may then quickly be checked. A positive result for this consistency test can establish the required validation for the game code of the reference image that has provided the highest score.

Another test for estimating the recognition reliability for the proposed game code can concern the value of the highest score itself. This value may be compared to a reliability threshold, separate from the preceding one, and the test is declared positive if the value is greater than or equal to the threshold, or negative in the opposite case. In this case, the value of the highest score can be provided as a value for estimating the reliability of the game code recognition.

Alternatively, different types of tests may also be used for estimating the reliability of the game code recognition. For example, imaging quality tests can be applied to the image which was captured in step ST2, or to the image portion that was selected in step ST5. For example, such tests may evaluate whether a contrast or sharpness of the image or image portion is sufficient for the subsequent game code recognition to be reliable. A person skilled in the art of imaging knows multiple tests that quantify the quality of an image.

Whatever test is used to evaluate the reliability of the game code recognition, when this test is negative, the validation of the proposed game code can be carried out in a manner similar to what has already been described for the test based on the difference between the two highest scores.

The recognition method just detailed for the case of the game code can be applied to any other graphic element of technical function which is printed on a play slip, and for which a reference image is available. Indeed, this method is independent of the nature and content of the graphic element of technical function. In particular, the game code may be replaced with a symbol of the game, for example a logo, acronym, sign, or icon, or by a graphic element of technical function such as an indicator for positioning the play slip in the image captured, in order to find other graphic elements at locations that are determined relative to these positioning indicators.

The reliability and robustness of the recognition method of the invention, which uses image comparison for graphic elements of technical function, avoids the use of pattern recognition methods. Because of this, it is no longer necessary for the positioning indicators which may be written on the play slips to have particular shapes and appearances compatible with pattern recognition algorithms, such as dark rectangles on the slip that are not aesthetically pleasing to the eye. In particular, the positioning indicators can be combined with other graphic elements which then serve multiple functions. Certain graphic elements of technical function can be merged with decorative elements and positioning indicators, or data encoding elements can be combined with positioning indicators. Similarly, a series of patterns can serve both as positioning indicators and game code. Such graphic elements fulfilling multiple technical functions can be detected in the play slip using approaches by points of interest or by analysis of connected components followed by calculating the moments, then are recognized using a comparison of images according to the invention.

It is understood that the invention can be reproduced according to multiple variants while retaining at least some of the benefits that have been mentioned. In particular, each step of image analysis or program execution can be implemented in many ways, all of which are accessible to the skilled person without inventive effort. Recall that most of the advantages of the invention result from the search for coincidence in the images, with no reading or interpretation step. The graphic element of technical function can then be printed on the slip in any manner, with image content characteristics that vary for different games.

1. Method for recognizing a graphic element of technical function which is printed on a play slip issued to a player, the technical function relating in particular to a selection or principle of the game, an implementation of the game, a printing of useful data, a use of the play slip, or a processing of said play slip, the method comprising the steps of:
/1/ providing a series of reference images that each contain a representation of a graphic element, in form of records of said reference images;
/2/ capturing at least one image of the slip issued to the player;
/3/ within the image of the slip, selecting an image portion that contains a reproduction of the graphic element as said graphic element appears on the slip;
/4/ comparing the reproduction of the graphic element contained in the selected image portion with each reference image, and for each of the reference images, obtaining a score that quantifies a similarity between the reproduction of the graphic element and the reference image; and
/5/ proposing the graphic element of the reference image for which the score is the highest as a graphic element that is recognized for the slip.

2. Method according to claim 1, wherein the graphic element is a game code or a game symbol.

3. Method according to claim 2, wherein step /3/ comprises the following substeps:
/3-1/ in the captured image of the slip, detecting position indicators printed on said slip; then
/3-2/ from the indicators, determining a position of the image portion which contains the reproduction of the graphic element as said graphic element appears on the slip,
and the image portion is selected in the image of the slip at the position determined in substep /3-2/.

4. Method according to claim 3, wherein substep /3-1/ itself comprises an identification, in the image captured in step /2/, of an area of said image which is occupied by the slip,
then the indicators are detected within the image area which is occupied by the slip.

5. Method according to claim 1, wherein:
an identification of a location of the reproduction of the graphic element in the slip is also provided in step /1/ for each reference image, then
step /3/ is repeated for each reference image, using the location identification that corresponds to the reference image for which step /4/ is then executed.

6. Method according to claim 1, wherein step /4/ itself comprises, for each reference image:
determining at least one imaging correction to be applied to the image portion which contains the reproduction of the graphic element as said graphic element appears on the slip, so that said correction increases the similarity between the reproduction of the graphic element and the reference image; and
determining the score quantifying the similarity between the reproduction of the graphic element as resulting from the imaging correction, and the reference image.

7. Method according to claim 6, wherein the imaging correction concerns at least one of the following parameters: level of brightness, contrast, sharpness, size, orientation or angle of view, for the reproduction of the graphic element as said graphic element appears in the image portion.

8. Method according to claim 1, further comprising, after step /5/, a test to estimate a reliability of the graphic element recognition, then
if the test is positive, the proposed graphic element is confirmed as the graphic element that is recognized on the slip, and
if the test is negative, an estimate of the reliability is generated,
the test being selected from among:
a comparison with a reliability threshold, of the difference between the highest score and the next highest score in descending order of the scores for all the reference images, the test being positive when said difference is greater than or equal to the reliability threshold;
a comparison of the highest score with a reliability threshold, the test being positive when said highest score is greater than or equal to the reliability threshold; and
an imaging quality sufficiency criterion, for the image portion which contains the reproduction of the graphic element as said graphic element appears on the slip.

9. Method according to claim 8, wherein, when the test is negative, a validation of the proposed graphic element is also required, and said validation is decided by the player or by a supplier of the slip to the player, or is decided using additional content of the slip relative to the reproduction of the graphic element.

10. Method according to claim 9, wherein the validation is automatically determined based on a consistency between the additional content of the slip and data associated with the proposed graphic element.

11. Method according to claim 10, wherein when the graphic element comprises a game code or a game symbol, the additional content comprises a selection from among multiple proposals which is written down by the player on the slip, and the data associated with the proposed game code or game symbol include game rules.

12. Method according to claim 1, implemented at a point of distribution of the play slip

13. Method according to claim 1, further comprising the following step, performed after step /5/:
/6/ carrying out a processing based on the graphic element of technical function as proposed in step /5/ as the recognized graphic element.

14. Device for recognizing a graphic element of technical function printed on a play slip, comprising:
means for storing a series of reference images that each contain a representation of a graphic element of technical function, in form of records of said reference images;
image capture means, adapted to capture at least one image of the play slip;
image analysis means, adapted to select, within an image of the play slip, an image portion that contains a reproduction of the graphic element of technical feature as said graphic element appears on the slip;
comparison means, adapted to compare the reproduction of the graphic element to each stored reference image so as to produce, for each of the reference images, a score that quantifies a similarity between the reproduction of the graphic element and the reference image; and
means for selecting the graphic element of technical function of the reference image for which the score is highest, and for proposing the selected graphic element as a recognized graphic element for the slip,
said device being adapted to automatically carry out a method according to claim 1.

15. Device adapted to automatically carry out a method according to claim 8, and further adapted to, when the test is negative, validate or not validate the proposed graphic element based on a consistency between an additional content of the slip further to the reproduction of the graphic element, and data associated with the proposed graphic element.

16. Device according to claim 15, further adapted to read a selection from among multiple proposals which is also written on the play slip, and when the graphic element is a game code or a game symbol, adapted to validate or not validate the proposed game code or game symbol based on the consistency between the selection read and game rules associated with the proposed game code or game symbol.

17. Device according to claim 14, further comprising means for carrying out a processing based on the proposed graphic element of technical function as a recognized graphic element.
